(19) United States
(12) Patent Application Publication
(10) Pub. No.: US 2010/0143538 A1
(43) Pub. Date: Jun. 10, 2010

(54) Dairy Product and Process

(75) Inventors: Ganugapati Vijaya Bhaskar, Palmerston North (NZ); Jordania Valentim, Palmerston North (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 12/516,174

(22) PCT Filed: Nov. 23, 2007
(86) PCT No.: PCT/NZ2007/000347

§ 371 Date: Feb. 18, 2010

(30) Foreign Application Priority Data
Nov. 23, 2006 (NZ) 551500

(51) Int. Cl. A23C 9/123

(52) U.S. Cl. 426/43

(57) ABSTRACT

A method for preparing a yoghurt is provided. The method comprises (a) preparing a calcium-depleted milk composition comprising either (i) calcium-depleting a starting milk composition, or (ii) including within a starting milk composition a calcium-depleted milk ingredient selected from milk, fat standardised milk, skim milk, or milk concentrate; and (b) acidifying the calcium-depleted milk composition with chemical acidification or lactic acid producing bacteria, to prepare a yoghurt, wherein the calcium depletion is by contacting the milk composition or ingredient with a cation exchanger to replace calcium in the composition or ingredient with sodium or potassium.

### TECHNICAL FIELD

The invention relates to a yoghurt, an ingredient for a yoghurt and a method for preparing a yoghurt.

### BACKGROUND ART

Yoghurt is a cultured product that is generally made by fermenting pasteurised milk, with or without the addition of dried milk products, with lactic-acid-producing bacteria. Yoghurt can be made from fresh milk and cream or from recombined milk powders and milkfat. Yoghurt may also contain very little or negligible fat. The pH is usually below 4.6. Variations may include fat content, protein content, total solids, and the addition of fruit and flavours and sweetening agents.

Texture is an important sensory attribute of yoghurt. For set-style and stirred-style yoghurts, consumers typically prefer a smooth creamy texture with a full body. Products described as thin, grainy, gritty or watery with or without syneresis (exuded whey) are not preferred. Yoghurt texture depends on many factors, including the protein composition and protein concentration, pH, type of culture used in the fermentation, heat treatment and calcium concentration.

The addition of soluble calcium salts to milk to improve gel strength has long been widely practiced in the art of cheese making.

The addition of common salt (NaCl) to a milk retentate has been disclosed by Moran et al. in U.S. Pat. No. 6,183,805 for the suppression of coagulation.

Tamime A. Y., Kalab M. & Davies G (Food Microstructure, 3, 83-92, 1984) studied the texture and microstructure of yoghurts prepared starting with skim milk and using a variety of fortifying methods (adding skim milk powder, adding sodium caseinate, ultrafiltering the starting milk, concentrating the starting milk by thermal evaporation and concentrating the starting milk by reverse osmosis) and 3 different starter cultures. The yoghurt fortified with sodium caseinate had the most open structure, was the firmest but had a coarse texture.

Guzmán-González et al. (Journal of Science of Food and Agriculture. 80, 433-438, 2000) examined yoghurt formulations with added milk proteins, including caseinate for viscosity and syneresis. They observed that the increase in the soluble calcium concentration in the mix by the addition of calcium caseinate or sodium-calcium caseinate increases the formation of a gel with less capacity for syneresis independently of the process employed in the acidification. They concluded that mixture enrichment with modified casein, caseinate by itself or mixed with other milk proteins yields firmer yoghurts than traditional fortification.

Remeuf et al. (International Dairy Journal 13, 773-782, 2003) teach that the fortification of yoghurt milk prior to heat treatment with sodium or calcium caseinate could be used to increase the complex viscosity of stirred yoghurt. Sodium caseinate was found to be superior to calcium caseinate.

Hansen & Fligner in U.S. Pat. No. 5,449,523 teach that yoghurt may be prepared by adding calcium fortified nonfat dry milk (skim milk powder) to a fat standardised milk stream.

Davis et al. in WO 99/18806 disclose that a creamy textured low fat yoghurt may be prepared using a dried whey powder ingredient enhanced with calcium and phospholipid.

Lowe et al. in WO 2005/016015 disclose that the texture of yoghurt may be manipulated by adjusting the casein to whey protein ratio (preferably by the addition of whey protein concentrate [WPC]) and heat treated at a predetermined pH.

Hood (US 20040208974 & US 20050084593) discloses methods of preparing a reduced carbohydrate yoghurt type product by ultrafiltering skim milk. Various stabilising agents are required that can include gelatine and a range of polysaccharides. A product with a calcium content of 0.10% to 0.12% by weight is claimed.

In JP63-188346, a method is disclosed for preparing an ingredient by treating a skim milk with ion exchange to replace a proportion of the calcium ions with a mixture of sodium and hydrogen ions. The ingredient is noted to have possible uses in cream products, meats and nutritional applications.

Stahl & Yuan (U.S. Pat. No. 4,450,182) disclose a method for producing a freeze-thaw stable ice-cream or dessert product by treating a low-fat milk stream by an ion exchange process to replace the majority of the calcium with sodium or potassium ions. The process requires the use of an alkaline equilibrating solution to prepare the weak cation exchange resin. The treated milk is pH adjusted with acid to neutralise it.

Schur in U.S. Pat. No. 4,066,794 discloses a dry powder instant yogurt preparation containing a variety of additives including EDTA. EDTA is disclosed as a sequestering agent that is essential to the present invention, for it functions to inhibit a precipitation reaction of the sodium alginate which in the absence of sequestration would tend, when water is admixed with the instant yogurt blend, to curdle and form lumps . . . .

Caseinate is a known ingredient to fortify set- or stirred-style yoghurts to improve texture. However, caseinate often imparts undesirable flavours, is expensive and has to be identified on the nutrition label of the product as an ingredient. Users prefer all-natural yoghurt, but for some consumers, the use of caseinate tarnishes the natural product image.

Lucey, Munro & Singh, (Rheological properties at small (dynamic) and large (yield) deformations of acid gels made from heated milk. Journal of Dairy Research, 64, 591-600 (1997)) examined the influence of heat treatments on the texture of acid gels prepared from milk.

Johnston & Murphy (Effects of some calcium-chelating agents on the physical properties of acid-set milk gels, Journal of Dairy Research, 59, 197-208 [1992]) demonstrate the effect of various anion treatments on the texture of acid milk gels.

Mistry & Hassan examined non-fat yoghurt fortified with high milk protein powder (84% protein) in Journal of Dairy Science 75, 947-957 [1992]. Also Modler et al. (Journal of Dairy Science 66, 422-429 [1983]) examined the physical and sensory properties of stirred-curd yogurts stabilized with milk proteins.

Another known means of enhancing the properties of yoghurt is the addition of hydrocolloids to the recipe. These can include polysaccharides and starches, alginate, pectin, carboxymethylcellulose, extra-cellular polysaccharides, microcrystalline cellulose [MCC], and gums such as carrageenan, guar and the like. The use of such ingredients can detract from the all-dairy, “pure” or “natural” product attractiveness of yoghurt to discerning consumers. Gelatine and whey protein are also commonly added to yoghurt.

It is an object of the present invention to provide a method for preparing a yoghurt with improved texture using dairy ingredients or at least to provide the public with a useful choice.

### DISCLOSURE OF THE INVENTION

In one aspect, the invention provides a method for preparing a yoghurt comprising:
(a) preparing a calcium-depleted milk composition comprising either
   i. calcium-depleting a starting milk composition, or
   ii. including within a starting milk composition a calcium-depleted milk ingredient selected from milk, fat standardised milk, skim milk, or milk concentrate, and
(b) acidifying the calcium-depleted milk composition with chemical acidification or lactic-acid-producing bacteria,
to prepare a yoghurt, wherein the calcium depletion is by contacting the milk composition or ingredient with a cation exchanger to replace calcium in the composition or ingredient with sodium or potassium.

In a preferred embodiment the calcium depletion is sufficient to increase the textural firmness of the yoghurt by at least 20%, preferably at least 30%.

Broadly the preparation of the calcium-depleted milk composition takes one or other (or a combination) of two routes—the Direct route [(a) i] above, or the Indirect route [(a) ii] above.

### Direct Route

Preferably, the staffing milk composition is milk or skim milk obtained from any dairy resource. Alternatively, the starting milk composition may include dried or liquid milk, milk retentate, milk protein concentrate (MPC), cream, or milk fat that are combined (with water if required) to form a reconstituted milk or a standardised milk composition. Milk streams may be pasteurised as required by local regulations.

The starting milk may be separated to provide a milk composition with a predetermined fat to solids-not-fat ratio.

In one embodiment, all or part of the starting milk may be passed through, or contacted with, an ion exchange resin bed comprising a cation exchange resin. Preferably the cation exchange resin is a strongly acidic cation exchange resin prepared in a form suitable to extract calcium ions from the milk and replace them with mono-valent cations, preferably sodium or potassium. Preferably the milk stream contacting the resin is a low fat milk.

Following treatment by ion exchange, the milk stream may be standardised for a predetermined fat to solids-not-fat ratio by the addition of a source of fat (if required) and standardised for a predetermined calcium to casein ratio by blending the resin treated stream with a milk stream. It may be further standardised by the addition of whey protein. This may be most conveniently achieved by adding a concentrated whey protein retentate, a microfiltered milk permeate, or dispersing and dissolving whey protein concentrate (WPC), or whey protein isolate (WPI).

### Indirect Route

In this embodiment, a calcium-depleted milk ingredient is prepared and added to a starting milk to attain the calcium-depleted milk composition.

Calcium-depleted milk ingredients may be prepared by known methods. These methods include those disclosed in published PCT applications WO01/41579 and WO01/41578, and US Patent applications 2003/0096036 and 2004/0197440, hereby incorporated by reference. Currently preferred are milk ingredients prepared by removal of calcium using cation exchange chromatography, preferably on a resin bearing strongly acidic groups (in the sodium or potassium form). Preferably, the pH of the milk material subjected to calcium depletion is adjusted to have a pH in the range 6.0-6.5 prior to ion exchange treatment. Any food approved acidulent may be used, but lactic acid and sources of lactic acid or citric is preferred. The calcium-depleted milk product may be used as a liquid ingredient or dried to produce a dried ingredient. The extent of calcium depletion may be varied by altering the chromatography conditions, for by varying the nature and volume of the resin, the nature and amount of milk material, the space velocity [ratio of volume flow rate to resin bed volume], the blending of treated milk with untreated milk, the temperature, pH etc.

Preferably, the calcium-depleted milk ingredient is added as a powder or a milk or a milk concentrate to the starting milk composition to attain the calcium-depleted milk composition. Preferred milk ingredients include milk, fat standardised milk, skim milk, or milk protein concentrate. These ingredients may all be used in liquid concentrate or powdered forms. In especially preferred embodiments, the calcium-depleted milk ingredient is a non-fat milk powder, a fat standardised milk powder, or liquid versions thereof.

In preferred embodiments of the invention, at least 15% of the exchangeable calcium in the milk ingredient has been replaced by sodium or potassium or both, preferably by sodium. More preferably at least 50% of the exchangeable calcium in the milk ingredient is replaced and most preferably at least 70% is replaced by sodium or potassium.

### Requirements of the Calcium-Depleted Milk Composition

The calcium-depleted milk composition is prepared according to the methods described above. A combination of the methods is contemplated, but not preferred.

In preferred embodiments, the calcium-depleted milk composition to be acidified comprises 5-75% less calcium than the corresponding composition with corresponding ingredients without calcium depletion by cation exchange, preferably 10-60%, more preferably 10-50%, most preferably 15-40% less calcium. The calcium-depleted milk composition may itself be a heat treated calcium-depleted milk composition.

In other preferred embodiments the calcium concentration of the calcium-depleted milk composition is 5-75%, preferably 10-60%, more preferably 10-50%, most preferably at least 15-40% lower than that of the corresponding composition in which the milk, fat standardised milk, skim milk, or combinations thereof is non-calcium-depleted.

In one embodiment, the calcium to casein weight ratio of the composition to be acidified is decreased relative to the corresponding composition prepared with no cation exchange by 5-75%, preferably 10-60%, more preferably 10-50%, most preferably 15-40%.

In one embodiment, the calcium concentration of the composition to be acidified is reduced to 300-900 mg/kg. The optimum calcium concentration varies according to the casein concentration in the yoghurt. A concentration in the range of 500-900 mg/kg is most appropriate for a yoghurt having a protein concentration of 2.9% with a casein to whey ratio substantially that of milk. For yoghurts with higher casein contents, higher levels of calcium are also useful. For example, a yoghurt having a protein concentration of 4.1% where the casein to whey ratio is substantially that of milk, the range may be extended from 500-900 mg/kg to 500-1300 mg/kg.

In another advantageous embodiment, the casein to whey protein ratio of the composition may be modified by for example the addition of a stream enriched in whey protein e.g. whey protein retentate (from the ultrafiltration of whey) or a whey protein permeate (from the microfiltration of milk) or reconstituted whey protein concentrate (WPC) or whey protein isolate (WPI).

Advantageous whey protein containing compositions include the range of casein to whey protein ratios (w/w) of 80 parts casein to 20 parts whey protein (typical of cows' milk) to 10 parts casein to 90 parts whey protein. More preferably the casein to whey protein ratio is between 70:30 and 20:80. Even more preferable are casein to whey protein ratios in the range 70:30 to 40:60.

Preferably, the calcium to casein weight ratio of the composition is in the range 0.017-0.055 w/w and most preferably 0.02-0.045 w/w. Also useful is a calcium to protein weight ratio of the composition is in the range 0.002-0.054, preferably 0.005-0.045, with 0.015-0.030 being often preferred, especially 0.020-0.030.

Once the calcium-depleted milk composition is obtained, the additional steps required to prepare the yoghurt may be affected.

Optionally, ingredients such as gelatine or hydrocolloids or polysaccharides may be added to the milk composition, preferably prior to the heat treatment step.

Preferably the material to be fermented may be homogenised using typical dairy processing methods. Two-stage homogenisation is preferred for fat containing yoghurt.

Heat treatment of the material to be fermented is preferred, prior to acidification. In addition to assisting with microbiological control, it causes denaturation of whey proteins and improves gel strength of the yoghurt and reduces syneresis. Preferably, the heat treatment is carried out 70-95° C. The preferred times vary according to the temperature. For temperatures of 80-85° C., typically used, 5-20 minutes is generally used. Following heat treatment, the mixture is cooled.

Conventional yoghurt manufacture procedures can be followed. Inoculation with yoghurt starters is well known to those skilled in the art. The method of the invention is applicable to the preparation of both stirred yoghurts and set yoghurts. The fermentation is carried out until the yoghurt has been formed. The fermentation may be allowed to proceed until a target pH, e.g. pH 4.5, has been reached.

Alternatively, acidification may be by chemical acidification, e.g. by adding glucono-delta-lactone (GDL).

In one embodiment of the invention, a fat standardised milk stream has added to it a proportion of the calcium-depleted ingredient selected from a non-fat milk powder, a fat standardised powder, or liquid streams thereof. The mixture, when fully dispersed and solubilised, is heat-treated at between 70° C. and 100° C. for between 1 minute and 30 minutes. After cooling to a temperature appropriate for fermentation, and inoculation with starter organisms, the mixture is held to allow fermentation to coagulate the mixture by the production of acid. At any convenient step in the process, optional additives may be included such as sweetening agents, flavouring and fruit or vegetable matter. The calcium-depleted ingredient may constitute from 10% to 95% of the mixture on a protein basis. More preferably the calcium-depleted ingredient may constitute from 20% to 90% of the mixture and most preferably between 30% and 80% of the mixture.

In another embodiment, the milk stream may comprise skim milk, or skim milk retentate.

In another aspect, the fat standardised calcium-depleted milk composition may be prepared as a fresh stream from milk, or may be prepared by recombining or reconstituting, some, or all, of the dairy stream from dry powders or dairy concentrates. Water, permeate or milk may be used as an intermediate solvent to disperse the dry powders or concentrates. The powders used to prepare the fat standardised calcium-depleted milk composition may be heat treated powders.

The calcium-depleted milk composition of this invention may be prepared to obtain yoghurt with a higher protein concentration than unfortified yoghurt, or may be prepared with a reduced protein concentration to attain an equivalent texture of unfortified yoghurt.

A preferred embodiment is shown in Scheme 1. More specifically, Scheme 1 shows possible process steps for the production of three generic types of yoghurt—set, stirred and drinking yoghurts.

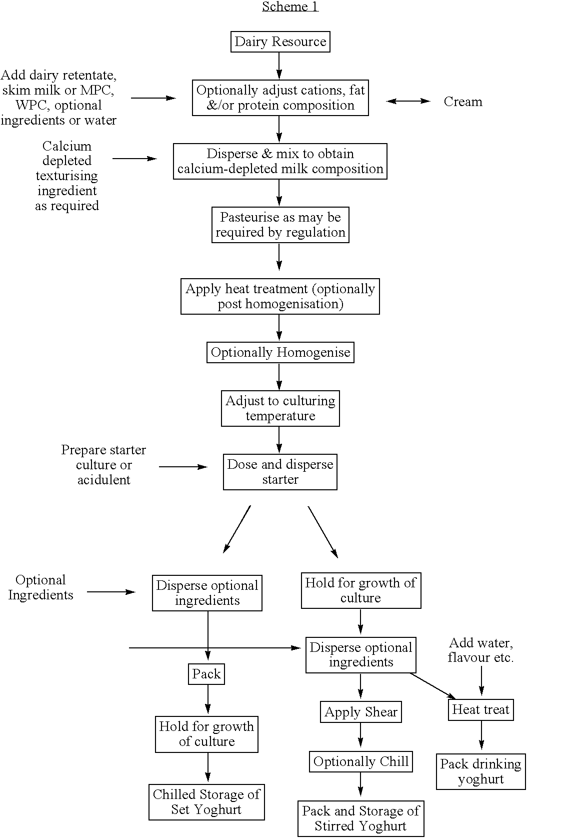

### DEFINITIONS

A “dairy resource” is any source of milk or milk ingredients useful for yoghurt manufacture. Dairy resources may be obtained from any lactating mammal and may be in a liquid or dry state. Milk from sheep, goats and especially cows is preferred. The dairy resource may have been heat treated to denature the proteins, especially the whey proteins (either on their own or in the presence of casein).

A “calcium-depleted milk composition” is a liquid composition prepared from a dairy resource wherein the liquid has a preferred composition selected from fat content, casein content, whey protein content, mono- and di-valent cation content.

“Yoghurt (yogurt)” refers to an acidic or fermented food or beverage product prepared from a dairy resource and viable micro-organisms. For the purposes of this invention yoghurt also refers to yoghurt-like products that may include non-dairy derived lipids, flavourings and food-approved stabilisers, acids and texturizers. Heat treated yoghurt and yoghurt-like products are also included by the term yoghurt. The term “yoghurt” includes yoghurts (either set or stirred), yoghurt drinks and Petit Suisse.

The term “calcium ions” refers broadly to divalent cations and includes ionic calcium or magnesium and colloidal forms of calcium or magnesium unless the context requires otherwise.

“Calcium-depleted” ingredients refers to milk compositions and ingredients in which the calcium or magnesium content is lower than the corresponding non-depleted composition or ingredient. These ingredients generally also have a lower content of divalent cations, for example, lower calcium or magnesium, or both, than corresponding non-depleted ingredients. Additionally, the mono-valent cation concentrations will be different to that of starting milk.

A “fat or protein standardised milk stream” is any milk composition (derived from any lactating mammal) used for making yoghurt that has a fat content of about 0.05% or more, and a protein content of at least 0.5%.

“Syneresis” is the propensity of the surface of a dairy gel to exude fluid—typically whey. Generally for yoghurt, the presence of free whey is a defect.

A “starter culture” is a term widely known in the art of preparing fermented dairy products. A starter culture is generally a nutrient medium containing high concentrations of viable micro-organisms capable of fermenting lactose. Strains derived from various families of lactic acid producing bacteria are commonly used e.g. Streptococcus thermophilus, and Lactobacillus delbrueckii subsp. Bulgaricus. Proprietary strains supplied from commercial sources are commonly used. Probiotic strains known to confer health benefits to yoghurt consumers are also known and may be used.

The term “milk concentrate” means any liquid or dried dairy-based concentrate comprising milk, skim milk, or milk proteins such that the concentrate has a casein to whey ratio between 1:9 and 9:1 by weight and a casein content above 3% (w/v). A milk protein concentrate is a preferred milk concentrate for use in the invention.

The term “milk protein concentrate” (MPC) refers to a milk protein product in which greater than 40%, preferably greater than 55%, most preferably 70% of the solids-not-fat (SNF) is milk protein (by weight on a moisture-free basis) and the weight ratio of casein to whey proteins is substantially the same as that of the milk from which it was prepared. Such concentrates are known in the art. MPCs are frequently described with the % dry matter as milk protein being appended to “MPC”. For example MPC70 is an MPC with 70% of the dry matter as milk protein.

The term “textural firmness” relates to instrumental means of assessing yoghurt texture. For set yoghurts, “textural firmness” relates to a measure of the set yoghurt to resist penetration by a 13 mm diameter probe travelling into the sample at 1 mm/s. For stirred or drinking yoghurt samples, “textural firmness” relates to the viscosity determined using a shear rate of 50 s⁻¹.

Hydrocolloids or polysaccharides refer to a wide range of ingredients that may be added to yoghurt in minor amounts (generally less than 5% w/w) for the purpose of altering the texture (firmness), mouthfeel (smoothness), or the stability of the product (reduce syneresis). Such ingredients include, carrageenan, various gums, alginate, pectin, starch and modified starch, soluble fibre, microcrystalline cellulose, modified cellulose and the like.

Optional additives may include any food additive permitted by the Codex Alimentarius Standard for Fermented Milks e.g. CODEX STAN 243-2003.

The term “comprising” as used in this specification means ‘consisting at least in part of’, that is to say when interpreting statements in this specification and claims which include that term, the features, prefaced by that term in each statement, all need to be present but other features can also be present.

### BRIEF DESCRIPTION OF THE DRAWINGS

### The Drawings

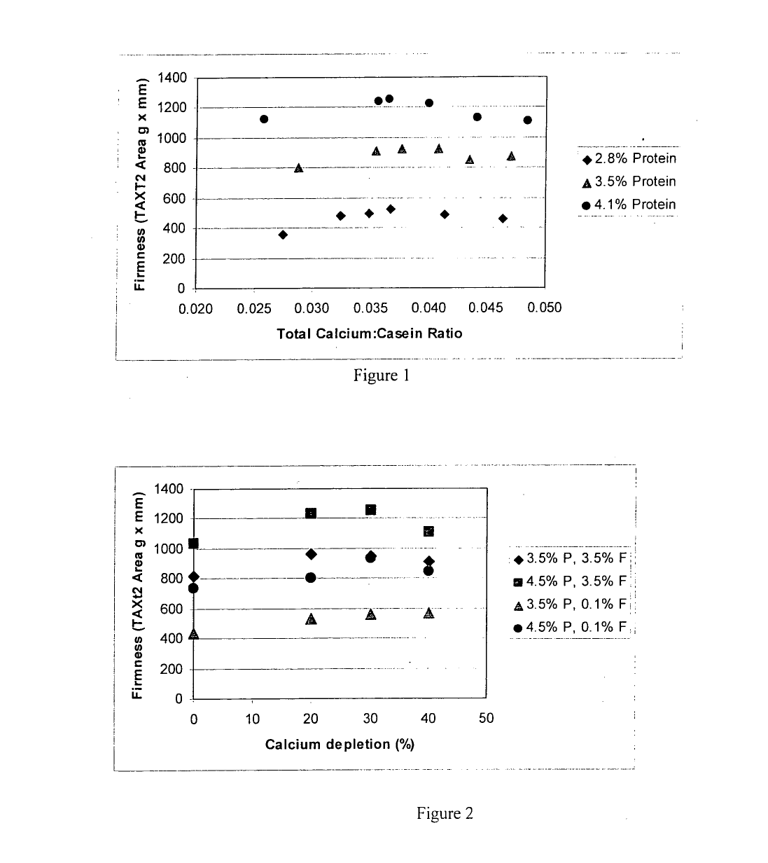

FIG. 1 shows the texture of set acid gel samples at various protein levels and calcium depletions.

FIG. 2 shows the texture of set yoghurts at various levels of calcium depletion, fat and protein.

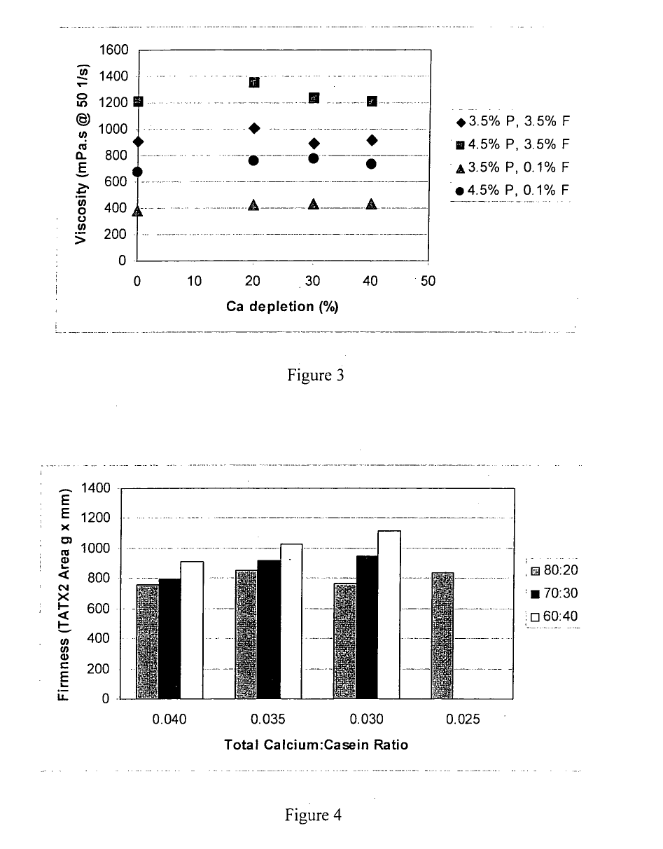

FIG. 3 shows the texture of stirred yoghurts at various levels of calcium depletion, fat and protein.

FIG. 4 shows textures of set yoghurts of varying casein to whey protein ratio at different calcium to casein ratios.

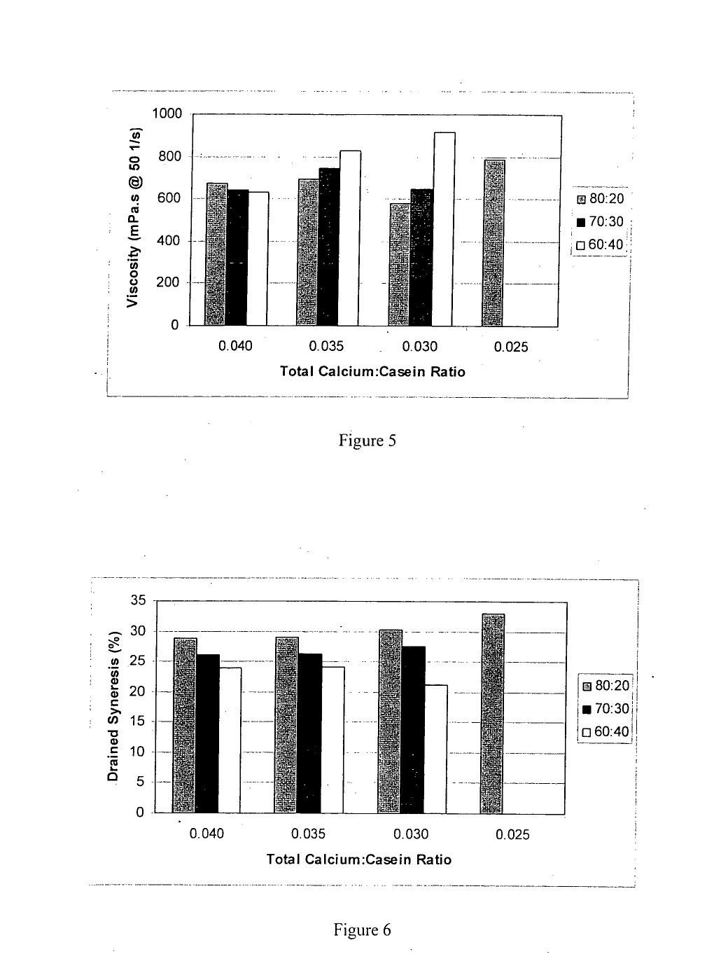

FIG. 5 shows viscosities of stirred curd samples of varying casein to whey protein ratio at different calcium to casein ratios.

FIG. 6 shows syneresis results of stirred curd samples of varying casein to whey protein ratio at different calcium to casein ratios

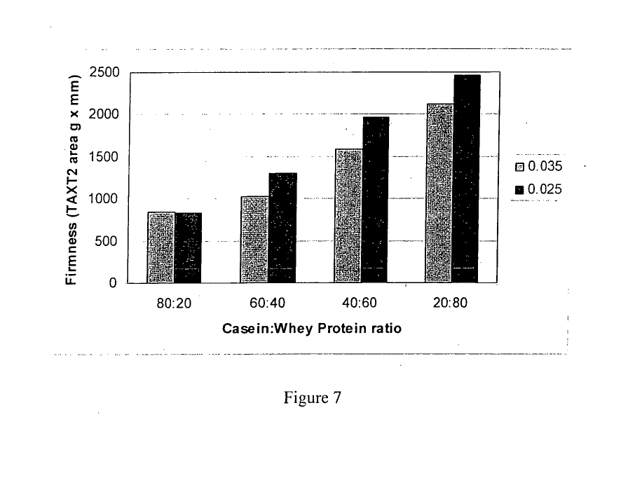

FIG. 7 shows yoghurt firmness as a function of casein to whey protein ratio and two levels of calcium depletion

### EXAMPLES

The following examples further illustrate the invention.

### Example 1

### Manufacture of Calcium-Depleted Milk Powder

1000 L of skim milk was adjusted to a pH of 5.8 using dilute citric acid (e.g. 3.3%). 100 L of the cation-exchange resin (IMAC HP111E, Rohm & Haas, bearing the sulphonate group in potassium form) was filled in a stainless steel vessel of about 40 cm diameter and a height of 100 cm or a total volume of 140 L. One hundred litres of resin bed had a height of 80 cm. The 1000 L of skim was then passed through the resin at 4 bed volumes an hour or 400 L of skim milk per hour. The resulting skim milk had about 25% of the original calcium, and was evaporated and dried to produce calcium-depleted skim milk powder of composition, on a moisture free basis, given in Table 1 and designated batch 2631.

TABLE 1
Cation composition of skim milk powder and
ion exchanged milk powder ingredient

| | Calcium | Magnesium | Sodium | Potassium |
|---|---|---|---|---|
| Ingredient | (% w/w) | (% w/w) | (% w/w) | (% w/w) |
| SMP (typical) | 1.25 | 0.12 | 0.35 | 1.6 |
| Calcium-depleted | 0.31 | 0.042 | 0.235 | 3.86 |
| ingredient (Batch | | | | |
| 2631) | | | | |

### Example 2

### Yoghurt Manufacture

Yoghurts were prepared in the following way. Initially a yoghurt milk base (Dairy resource) was prepared by using: 44 g of anhydrous milk fat [AMF] (Fonterra Co-operative Group Limited, Auckland), 132 g of low heat skim milk powder [SMP] [typically about 1250 mg Ca per 100 g powder and 34% protein] (Fonterra Co-operative Group Limited, Auckland), 264 g standard whole milk powder [WMP] [typically about 26% fat and 26% protein] (Fonterra Co-operative Group Limited, Auckland), 360 g of sugar (Chelsea, New Zealand Sugar Refining Co, Auckland), and 3083.6 g of water. This resulted in a yoghurt with about 2.8% protein and about 2.2% casein w/w.

The yoghurt milk base was allowed to stand for 1 h, then heated to 65° C. and 2-stage homogenised [150/50 bar], followed by a heat treatment of 85° C. for 15 minutes, cooling to 38° C. A thermophilic starter culture using YC-350 (FD-DVS YC-350—YO Flex, Chr-Hansen A/S, Hoersholm, Denmark) was pre-prepared (see below) and added to the yoghurt milk at an addition level of 116.4 g (2.91% of the total weight) for all trials [making a total batch of 4,000 g], mixed and left to ferment until the pH reached 4.5 (approx. 6 h). For stirred yoghurt, a batch of the set yoghurt was then cooled to 20° C., passed through a shear pump (homogeniser without applied back pressure). Samples of the set and stirred yoghurts were stored in a refrigerator at 5° C. for at least two days prior to evaluation.

Starter culture using YC-350 was prepared by autoclaving (approximately 120° C. for 10 minutes) a suitable quantity of skim milk. Once cooled to about 38° C., the milk was inoculated at the rate of 0.002% with YC-350 and placed in an incubator (37° C.) and held overnight. The starter culture now at a pH of about 4.5 was placed in a refrigerator until required. The starter strains were selected because YC-350 culture produces low viscosity yoghurts and is well suited for examining the effects of milk composition on yoghurt texture. YC-350 is a mixed strain culture containing:
Streptococcus thermophilus, and
Lactobacillus delbrueckii subsp. bulgaricus.

Three batches of trial yoghurt were prepared where 1/3, 2/3 and 3/3 of the SMP was replaced with calcium-depleted [ion exchanged] powder ingredient wherein approximately ⅔ of the original calcium had been replaced with potassium. A control yoghurt, where none of the SMP was replaced, was also prepared. All the batches contained 2.8% protein.

### Evaluation of Texture

Set yoghurts were tested 2 days after manufacture. The gel penetration was measured using Universal TA-XT2 texture analyser (Universal TA-XT2 Texture Analyser with a real time graphics and data acquisition software package (XTRA Dimension) from Stable Micro Systems, Godalming, United Kingdom) using 13 mm diameter probe that was driven into the sample (at 5° C.) at 1 mm/s for a distance of 20 mm and withdrawn at the same rate. The response was measured as the area under the force versus displacement curve to give the gel penetration effort (work expended during sample deformation, g×mm).

For the stirred yoghurts, apparent viscosity at a shear rate of 50 s⁻¹ was measured at 10° C. using a Haake VT500 viscometer (Haake Mess-Technik, GmbH., Karlsruhe, Germany).

The texture results for the set yoghurts are summarised in Table 2.

TABLE 2
Effect of SMP replacement with calcium-depleted
milk powder on gel penetration effort

| | Ratio SMP:Ca-depleted ingredient (%) | | | |
|---|---|---|---|---|
| | 100:0 | 67:33 | 33:67 | 0:100 |
| Yoghurt calcium (mg/kg) | 1070 | 970 | 870 | 760 |
| Calcium/casein in | 0.047 | 0.042 | 0.038 | 0.033 |
| yoghurt (w/w) | | | | |
| Gel penetration effort | 450 | 600 | 730 | 600 |
| (g × mm) | | | | |

### Syneresis

A sample of approximately 38 g of yoghurt at 5° C. was placed on a 150# stainless steel gauze. The material that drained through the mesh was collected over 2 h and weighed. The percentage syneresis was the ratio of drained weight/original sample weight×100.

TABLE 3
Effect of SMP replacement with calcium-depleted
milk powder on syneresis

| | SMP calcium replacement | | | |
|---|---|---|---|---|
| | 0% | 33% | 67% | 100% |
| | replacement | replacement | replacement | replacement |
| Calcium/casein | 0.047 | 0.042 | 0.038 | 0.033 |
| in yoghurt | | | | |
| (w/w) | | | | |
| Syneresis (%) | 41 | 37 | 32 | 35 |

The inventors have found that by replacing a proportion of the divalent cations (principally calcium) with monovalent cations (potassium) the texture of the yoghurt was improved and the syneresis was reduced. No caseinate or hydrocolloids were used in the yoghurt formulation.

### Example 3

### GDL Trials—Optimum Level of Calcium Depletion

The samples prepared above (2.8% protein) using live cultures were compared using a chemical slow release acidulent—GDL. The same textural and syneresis behaviour with this model system was obtained. (See below.) Direct acidification is a simpler process for laboratory trials and is subject to less variability as it does not rely on the vagaries of starter culture growth. Experiments continued using GDL as a proxy for live culture growth in yoghurt samples.

The next set of experiments established the equivalence of GDL acidification and starter culture acidification at 2.8% protein and then examined the effect of calcium substitution at higher protein levels.

Lab Scale Milk Processing with Acidification by GDL:
1. Recombine the milk powder blends with lactose and water to make 430 g of milk
2. Stir at 55° C. for 30 min.
3. Heat to 85° C. in a hot water bath and hold at 85-88° C. for 15 min.
4. Cool to 10° C. in an ice/water bath and store in the fridge until next day.
5. Then warm the milks to 42° C. and add GDL as follows:
   for 2.8% protein milks, add 1.4% GDL,
   for 3.5% protein milks, add 1.7% GDL,
   for 4.1% protein milks, add 1.9% GDL.
6. Pour the milks into 3×125 mL pots—leftover residue used to check pH.
7. Incubate at 42° C. for around 5 hours (until pH is approx 4.2).
8. Then remove the set gels from the incubator and store them at 5° C.
9. Test texture using the TA XT2 texture analyser after 2 days storage.

Using the basic method in Example 1, a second batch of calcium-depleted milk powder was prepared designated—IX SMP A1761. A1761 had approximately 95% of the calcium of the source milk replaced and had the following composition:

| | |
|---|---|
| Protein % | 30.7 |
| Fat % | 0.7 |
| Lactose % | 59.8 |
| Ash % | 8.3 |
| Moisture % | 4.8 |
| Calcium mg/kg | 280 |

### Gel Milk Formulations

The formulations for the milk gels at differing protein contents and different levels of calcium depletion are given in Tables 4, 5 & 6.

TABLE 4
Formulations for 2.8% protein acid gels

| | % Calcium Depletion | | | | | |
|---|---|---|---|---|---|---|
| | Control | | | | | |
| Ingredient (g) | 0 | 10 | 20 | 20 | 30 | 40 |
| IX SMP | 0.00 | 0.98 | 1.85 | 2.28 | 2.70 | 3.62 |
| A1761 | | | | | | |
| SMP | 9.00 | 7.92 | 6.95 | 6.48 | 6.01 | 4.99 |
| Lactose | 0.00 | 0.07 | 0.15 | 0.18 | 0.22 | 0.29 |
| GDL | 1.4 | 1.4 | 1.4 | 1.4 | 1.4 | 1.4 |
| Water | 89.6 | 89.63 | 89.65 | 89.66 | 89.67 | 89.7 |
| Total | 100 | 100 | 100 | 100 | 100 | 100 |

TABLE 5
Formulations for 3.5% protein acid gels

| | % Calcium Depletion | | | | | |
|---|---|---|---|---|---|---|
| | Control | | | | | |
| Ingredient (g) | 0 | 10 | 20 | 20 | 30 | 40 |
| IX SMP | 0.00 | 1.30 | 2.47 | 3.04 | 3.60 | 4.82 |
| A1761 | | | | | | |
| SMP | 12.00 | 10.56 | 9.27 | 8.64 | 8.02 | 6.66 |
| Lactose | 0.00 | 0.10 | 0.19 | 0.23 | 0.27 | 0.38 |
| GDL | 1.7 | 1.7 | 1.7 | 1.7 | 1.7 | 1.7 |
| Water | 86.3 | 86.34 | 86.37 | 86.39 | 86.41 | 86.44 |
| Total | 100 | 100 | 100 | 100 | 100 | 100 |

TABLE 6
Formulations for 4.1% protein acid gels

| | % Calcium Depletion | | | | | |
|---|---|---|---|---|---|---|
| | Control | | | | | |
| Ingredient (g) | 0 | 10 | 20 | 20 | 30 | 40 |
| IX SMP | 0.00 | 1.47 | 2.77 | 3.42 | 4.05 | 5.43 |
| A1761 | | | | | | |
| SMP | 13.50 | 11.87 | 10.43 | 9.72 | 9.02 | 7.49 |
| Lactose | 0.00 | 0.12 | 0.22 | 0.27 | 0.32 | 0.43 |
| GDL | 1.9 | 1.9 | 1.9 | 1.9 | 1.9 | 1.9 |
| Water | 84.6 | 84.64 | 84.68 | 84.69 | 84.71 | 84.75 |
| Total | 100 | 100 | 100 | 100 | 100 | 100 |

### Results

The texture of the resulting gels are summarised in FIG. 1.

FIG. 1 shows that there is an optimal level of cation depletion that maximises texture for a range of protein levels that relate to typical yoghurt products in the marketplace. More specifically, the optimum calcium to casein ratios (expressed by weight) are identified to occur between about 0.030 and 0.045 for a casein to whey protein ratio typical of cows' milk of about 80:20.

### Example 4

### Yoghurt Containing Fat Samples Prepared (by Fermentation)

A further set of experiments examined the effect of different levels of fat, protein and calcium depletion levels on yoghurt texture. Variable levels were as follows:

| | |
|---|---|
| Protein | 3.5 and 4.5% |
| Fat | 0.1% and 3.5% |
| Calcium depletion levels | 0, 20, 30 and 40% |

### Formulations

The formulations for the series of yoghurts with different fat levels are summarised in Tables 7 & 8.

Low Fat

TABLE 7
Recipes used to prepare low fat yoghurt samples (%)

| | % Protein | | | | | | | |
|---|---|---|---|---|---|---|---|---|
| | | 3.5% | 3.5% | 3.5% | | 4.5% | 4.5% | 4.5% |
| | 3.5% | 20% | 30% | 40% | 4.5% | 20% | 30% | 40% |
| | Control | depletion | depletion | depletion | Control | depletion | depletion | depletion |
| IX SMP | 0.00 | 2.37 | 3.52 | 4.67 | 0.00 | 3.03 | 4.50 | 5.97 |
| Fully Ca | | | | | | | | |
| Deplete | | | | | | | | |
| A1761 | | | | | | | | |
| SMP | 10.47 | 8.30 | 7.25 | 6.20 | 13.47 | 10.70 | 9.35 | 8.00 |
| Lactose | 0.43 | 0.22 | 0.11 | 0.00 | 0.53 | 0.26 | 0.13 | 0.00 |
| Culture | 0.002 | 0.002 | 0.002 | 0.002 | 0.002 | 0.002 | 0.002 | 0.002 |
| (MY 800) | | | | | | | | |
| Water | 89.10 | 89.11 | 89.12 | 89.13 | 86.00 | 86.01 | 86.02 | 86.03 |
| SUM | 100.00 | 100.00 | 100.00 | 100.00 | 100.00 | 100.00 | 100.00 | 100.00 |

3.5% Fat

TABLE 8
Recipes used to prepare fat containing yoghurt samples (%)

| | % Protein | | | | | | | |
|---|---|---|---|---|---|---|---|---|
| | | 3.5% | 3.5% | 3.5% | | 4.5% | 4.5% | 4.5% |
| | 3.5% | 20% | 30% | 40% | 4.5% | 20% | 30% | 40% |
| | Control | depletion | depletion | depletion | Control | depletion | depletion | depletion |
| IX SMP | 0.00 | 2.37 | 3.52 | 4.67 | 0.00 | 3.03 | 4.50 | 5.97 |
| Fully Ca | | | | | | | | |
| Deplete | | | | | | | | |
| A1761 | | | | | | | | |
| SMP | 10.47 | 8.30 | 7.25 | 6.20 | 13.47 | 10.70 | 9.35 | 8.00 |
| AMF | 3.43 | 3.43 | 3.43 | 3.43 | 3.41 | 3.41 | 3.41 | 3.41 |
| Lactose | 0.43 | 0.22 | 0.11 | 0.00 | 0.53 | 0.26 | 0.13 | 0.00 |
| Culture | 0.002 | 0.002 | 0.002 | 0.002 | 0.002 | 0.002 | 0.002 | 0.002 |
| (MY 800) | | | | | | | | |
| Water | 85.7 | 85.7 | 85.7 | 85.7 | 82.6 | 82.6 | 82.6 | 82.6 |
| SUM | 100.00 | 100.00 | 100.00 | 100.00 | 100.00 | 100.00 | 100.00 | 100.00 |

### Results

The properties of the yoghurt samples are summarised in Tables 9 & 10.

Low Fat

TABLE 9
Summary of results for low fat set and stirred yoghurt samples

| | | | | Firmness |
|---|---|---|---|---|
| | | Viscosity | Syneresis | (area |
| | pH | (mPa × s at 50⁻¹) | (%) | g × mm) |
| 3.5% Control | 4.3 | 384 | 41 | 438 |
| 3.5% 20% depletion | 4.3 | 425 | 41 | 532 |
| 3.5% 30% depletion | 4.3 | 438 | 39 | 559 |
| 3.5% 40% depletion | 4.3 | 436 | 41 | 566 |
| 4.5% Control | 4.4 | 677 | 27 | 734 |
| 4.5% 20% depletion | 4.4 | 763 | 25 | 805 |
| 4.5% 30% depletion | 4.4 | 774 | 26 | 933 |
| 4.5% 40% depletion | 4.4 | 732 | 28 | 847 |

3.5% Fat

TABLE 10
Summary of results for fat containing
set and stirred yoghurt samples

| | | | | Firmness |
|---|---|---|---|---|
| | | Viscosity | Syneresis | (area |
| | pH | (mPa × s at 50 s⁻¹) | (%) | g × mm) |
| 3.5% Control | 4.4 | 909 | 24 | 818 |
| 3.5% 20% depletion | 4.4 | 1008 | 23 | 962 |
| 3.5% 30% depletion | 4.4 | 888 | 24 | 948 |
| 3.5% 40% depletion | 4.4 | 920 | 23 | 914 |
| 4.5% Control | 4.4 | 1210 | 18 | 1036 |
| 4.5% 20% depletion | 4.4 | 1347 | 17 | 1229 |
| 4.5% 30% depletion | 4.4 | 1229 | 16 | 1256 |
| 4.5% 40% depletion | 4.4 | 1206 | 16 | 1107 |

FIGS. 2 & 3 show that for both set and stirred yoghurts (with or without fat and high and low levels of protein) there was a preferred level of calcium depletion in the range about 10% to 40%.

### Example 5

### Effect of Altering Casein to Whey Protein Ratio and Calcium Depletion

### Background

Depletion of calcium in milk is believed to affect the casein micelles and the behaviour of the caseins present in the milk. The changes to the casein in the yoghurt milk lead to surprising gains in texture and reductions in syneresis.

The yoghurt milks investigated to date have had a casein:whey protein ratio of 80:20. It is known that altering the casein:whey ratio affects yoghurt texture and syneresis. What is not known is how altering the calcium:casein ratio in conjunction with the casein:whey ratio affects yoghurt texture and syneresis.

### Experimental

IX SMP A1761 was a highly calcium-depleted potassium skim milk powder prepared according to the methods of WO01/41579 and WO01/41578 as detailed in Example 1.

WPC A421 (56% protein whey protein concentrate prepared from cheese whey. A421 was supplied by Fonterra Co-operative Group Limited, Auckland.) [Calcium concentration is 500 mg/100 g.]

WPC 392 (80% protein, whey protein concentrate prepared from cheese whey. Supplied by Fonterra Co-operative Group Limited, Auckland.) [Calcium concentration is 400 mg/100 g.]

### Experimental Plan/Variables

Yoghurt samples were prepared by lactic fermentation using commercial starter culture MY800 (Danisco A/S, Denmark) using an addition rate of 0.002%.

| | |
|---|---|
| Protein Level | 4.5% |
| Fat Level | 0.5% |

Calcium:casein ratios 0.039, 0.034 and 0.03
Casein:whey ratios 80:20, 70:30 and 60:40

### Formulations

For each formulation, two samples were prepared—a set yoghurt and a stirred yoghurt.

The formulations are shown in Table 11 with the ingredient quantities expressed in g.

TABLE 11
Formulations of yoghurts with defined calcium depletions and casein to whey protein ratios (cas:WP)

| | Cas:WP | | | | | | | | |
|---|---|---|---|---|---|---|---|---|---|
| | 80:20 | 80:20 | 80:20 | | | | | | |
| | Control | Control | Control; | 70:30 | 70:30 | 70:30 | 60:40 | 60:40 | 60:40 |
| Calcium/casein | 0.039 | 0.035 | 0.030 | 0.039 | 0.035 | 0.030 | 0.039 | 0.035 | 0.030 |
| IX SMP | 149.5 | 247 | 344.5 | 169 | 253.5 | 338 | 182 | 256.8 | 328.3 |
| A1761 | | | | | | | | | |
| SMP | 737.8 | 648.1 | 559 | 611 | 533 | 455 | 487.5 | 419.3 | 354.3 |
| WPC 421 | 0 | 0 | 0 | 65 | 65 | 65 | 130 | 130 | 130 |
| Lactose | 17.6 | 9.1 | 0 | 55.9 | 48.8 | 41.6 | 97.5 | 89.7 | 82.6 |
| MY800 | 0.13 | 0.13 | 0.13 | 0.13 | 0.13 | 0.13 | 0.13 | 0.13 | 0.13 |
| Water | 5595 | 5596 | 5596 | 5599 | 5600 | 5600 | 5603 | 5604 | 5605 |

| | Cas:WP | | | |
|---|---|---|---|---|
| | 40:60 | 40:60 | 20:80 | 20:80 |
| Calcium/casein | 0.035 | 0.025 | 0.035 | 0.025 |
| IX SMP | 260 | 364 | 154.7 | 208 |
| A1761 | | | | |
| SMP | 197 | 100.8 | 81.3 | 32.5 |
| WPC 421 | 260 | 260 | 0 | 0 |
| WPC 392 | 0 | 0 | 273 | 273 |
| Lactose | 8.5 | 0 | 4.6 | 0 |
| MY800 | 0.13 | 0.13 | 0.13 | 0.13 |
| Water | 5775 | 5775 | 5986 | 5986 |

### Method of Preparation

Preparation of Starter Culture

The amount of freeze-dried starter necessary for inoculation was calculated as 0.002% starter culture×6.5 L milk per yoghurt sample. The required amount of starter culture was weighed out and added to warm (40° C.) skim milk (10 mL milk per yoghurt sample). The milk was agitated to disperse/dissolve the starter culture and then held at 40° C. for 30 minutes.

Preparation of Yoghurt Milk

Warm water was weighed into large beakers. The dry ingredients for each formulation (Table 11) were added and dispersed in the water to form the yoghurt milk base. The yoghurt milk base was allowed to stand for 1 h, then heated to 65° C. and 2-stage homogenised [150/50 bar], followed by a heat treatment of 85° C. for 15 minutes, and then cooled to about 42° C. 10 mL of inoculated starter milk is then added to each sample, mixed and left to ferment until the pH reached 4.5 (approx. 6 h). The yoghurt was then cooled to 5° C. (set yoghurt) or 20° C. (stirred yoghurt). For the stirred yoghurt, a portion of the yoghurt curd was passed through a shear pump (back pressure valve) and stored at 5° C.

### Results

The properties of the yoghurt samples are summarised in FIGS. 4, 5 & 6.

### Conclusions

Experiments have revealed that both syneresis (FIG. 6 with casein to whey proteins of 80:20, 70:30 & 60:40) and texture (FIG. 7 with calcium to casein ratios of 0.025 & 0.035) were both improved by the manipulation of both the extent of calcium removal and an increase in the ratio of whey protein to casein.

### Example 6

### Preparation of Petit Suisse (PS) and Drinking Yoghurt

WPC 132 (NZMP Whey Protein Concentrate 132 from Fonterra Co-operative Group Limited, Auckland) is a whey protein concentrate manufactured from fresh acid casein whey.

IX SMP A1761 details as given above.

The formulations for samples of drinking yoghurt and Petit Suisse are shown in Table 12,

TABLE 12
Ingredients and formulations (%) for PS and drinking yoghurt samples

| | | PS calcium- | | Drinking Yoghurt |
|---|---|---|---|---|
| | PS (Control) | depleted | Drinking Yoghurt | calcium-depleted |
| Ingredient | [% w/w] | [% w/w] | (Control) [% w/w] | [% w/w] |
| IX SMP A1761 | 0 | 4.248 | 0 | 2.55 |
| SMP | 8.163 | 4.266 | 9.568 | 7.25 |
| WPC 132 | 0.486 | 0.486 | 0 | 0 |
| Lactose | 0.351 | 0 | 0.832 | 0.58 |
| 3.3% fat milk | 82.89 | 82.89 | 0 | 0 |
| 40% fat cream | 8.1 | 8.1 | 2.4 | 2.4 |
| Culture R708 | 0.01 | 0.01 | | |
| (Chr Hansen | | | | |
| A/S, Denmark) | | | | |
| Culture MY800 | | | 0.002 | 0.002 |
| Water | 0 | 0 | 87.2 | 87.22 |
| Total | 100 | 100 | 100 | 100 |

Table 13 summarises the viscosity and syneresis results for the Petit Suisse and drinking yoghurt samples.

TABLE 13
Results taken at day 7 from Petit
Suisse and Drinking Yoghurt samples

| | | Viscosity | Drained |
|---|---|---|---|
| Sample | pH | (@ 50 s⁻¹) [mPa × s] | Syneresis (%) |
| PS Control | 4.42 | 1570 | 7.1 |
| PS Calcium-depleted | 4.47 | 1620 | 7.3 |
| Drinking Yoghurt | 4.33 | 249 | 37.8 |
| Control | | | |
| Drinking Yoghurt | 4.32 | 374 | 37.1 |
| Calcium-depleted | | | |

For both the PS and drinking yoghurt samples the calcium-depleted samples were functionally improved compared to the controls.

### Sensory Evaluation

A seven-member panel was used to evaluate the texture of the PS and drinking yoghurt samples using a 5-point evaluation scale (where zero represented no obvious difference and 5 represented and extremely desirable difference). For visual and in-mouth texture of all the samples were rated at least as good as the corresponding controls. The average scores are shown in Table 14.

TABLE 14
Average panel scores

| | | Drinking yogurt |
|---|---|---|
| | PS (Mean difference | (Mean difference |
| | [sample − control]) | [sample − control]) |
| Visual texture | 0.8 | 1.3 |
| In-mouth texture | 0.9 | 1.4 |
| Smoothness | 0.6 | 0.3 |

### Example 7

### Effect of Calcium Depletion on Yoghurts Prepared Directly from Milk

### Milk Preparation Method

Clean and regenerated ion exchange resin in the sodium form (Amberlite SR1L-Rohm&Haas) was added with stirring to Anchor Trim milk (pH 6.7, 5-10° C.).

The milk/resin mixtures were gently stirred until the pH of the milk was stable (about one hour). The level of calcium in the milk was determined by back titration using a complex with EDTA and Patton-Reeder indicator.

The ion exchange resin was removed by straining the mixture through a cheesecloth. The pH of the milk was adjusted back to 6.7 with 1M HCl prior to yoghurt making.

| Target Calcium Depletion | 25% | 90% |
|---|---|---|
| Trim milk volume (L) | 5 | 5 |
| Resin (g) | 100 | 850 |
| Final pH (after stabilising) | 7.0 | 7.5 |

Amberlite SR1L-Rohm&Haas Ion Exchange Resin Cleaning and Regeneration

The resin was cleaned by passing four bed volumes of 1% NaOH solution through it, followed by flushing with at least four bed volumes of RO water until the conductivity was less than 50 uS/cm.

The resin was regenerated between runs by passing four bed volumes of 2M NaCl through it, followed by flushing with at least two bed volumes of RO water until the conductivity was less than 50 uS/cm.

Trim milk (Anchor Trim Milk, Fonterra Brands (NZ) Ltd, Auckland)

The compositions of the milks used for the samples are shown in Table 15.

TABLE 15
Summary of milk compositions

| | Trim Milk | 20% calcium- | 70% calcium- |
|---|---|---|---|
| | (Control) | depleted milk | depleted milk |
| Protein % | 3.9 | 3.6 | 3.6 |
| Fat % | <0.1 | 0.02 | 0.05 |
| Lactose % | 5.4 | 5.3 | 5.02 |
| Total Solids % | 9.4 | 8.9 | 8.4 |
| Calcium (mg/kg) | 1470 | 1170 | 465 |

Samples were prepared according to the formulations given in Table 16.

TABLE 16
Formulations used to prepare yoghurt
samples from fresh milk (% w/w)

| | | | “20%” Calcium-depleted |
|---|---|---|---|
| | | 20% Calcium- | (Trim milk + 70% |
| Ingredient | Trim Milk | depleted | Calcium-depleted) |
| Trim milk % | 92.2 | | 57.0 |
| 20% Calcium- | | 100.0 | |
| depleted milk % | | | |
| 70% Calcium- | | | 39.8 |
| depleted milk % | | | |
| Lactose % | 0.29 | | 0.23 |
| Culture | 0.002 | 0.002 | 0.002 |
| (MY 800) % | | | |
| Water % | 7.51 | | 2.97 |
| Sum % | 100 | 100 | 100 |

### Results

The properties of the yoghurt samples are summarised in Table 17.

TABLE 17
Properties of set and stirred yoghurt samples prepared from milk

| | | | | Firmness |
|---|---|---|---|---|
| | | Viscosity | Syneresis | (area |
| | pH | (mPa × s at 50 s⁻¹) | (%) | g × mm) |
| Trim Milk | 4.3 | 307 | 50 | 333 |
| 20% Calcium- | 4.4 | 383 | 40 | 528 |
| depleted | | | | |
| “20%” Calcium- | 4.3 | 413 | 41 | 475 |
| deplete (Trim + | | | | |
| 70% Calcium- | | | | |
| depleted) | | | | |

The experiment demonstrated that improved yoghurt of this invention could be prepared by reducing the calcium content of a fresh milk stream used directly for yoghurt production. Therefore the invention can be practiced with equal facility (according to convenience) by using a dairy resource that is based on fresh liquid milk or based on reconstituted powder, or any combination. The calcium depletion may be performed on the milk stream to be used directly in yoghurt preparation or on a dairy stream that is subsequently dried for eventual incorporation in a yoghurt milk stream. The level of calcium depletion may be adjusted accordingly to give the efficacious calcium level desired in the final yoghurt milk composition.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The above examples are illustrations of the practice of the invention. It will be appreciated by those skilled in the art that the invention can be carried out with numerous modifications and variations. For example, the calcium-depleted ingredients used can show variations in protein concentration and calcium content. The method of calcium depletion can be varied. The percentage calcium depletion and drying procedures can also be varied. Likewise, the proportions of components, the acidification method, and incubation conditions may be varied.

1. A method for preparing a set or stirred yoghurt comprising:
a. preparing a calcium-depleted milk composition comprising either
i. calcium-depleting a starting milk composition, or
ii. including within a starting milk composition a calcium-depleted milk ingredient selected from milk, fat standardised milk, skim milk, or milk concentrate, and
b. acidifying the calcium-depleted milk composition with chemical acidification or lactic-acid-producing bacteria,
to prepare a yoghurt, wherein the calcium depletion is by contacting the milk composition or ingredient with a cation exchanger to replace calcium in the composition or ingredient with sodium or potassium.

2. A method as claimed in claim 1, wherein the calcium depletion is sufficient to increase the textural firmness of the yoghurt by at least 20%.

3.-13. (canceled)

14. A method as claimed in claim 1, wherein the casein to whey protein weight ratio is between 70:30 and 20:80.

15. A method for preparing a yoghurt comprising:
a. preparing a calcium-depleted milk composition comprising either
iii. calcium-depleting a starting milk composition, or
iv. including within a starting milk composition a calcium-depleted milk ingredient selected from milk, fat standardised milk, skim milk, or milk concentrate;
wherein the casein to whey ratio of the starting milk composition is decreased by addition of a stream enriched in whey protein; and
b. acidifying the calcium-depleted milk composition with chemical acidification or lactic-acid-producing bacteria,
to prepare a yoghurt, wherein the calcium depletion is by contacting the milk composition or ingredient with a cation exchanger to replace calcium in the composition or ingredient with sodium or potassium.

16. A method as claimed in claim 15, wherein the calcium depletion is sufficient to increase the textural firmness of the yoghurt by at least 20%.

17. A method as claimed in claim 15, wherein a calcium-depleted milk ingredient is included as an ingredient that is a powder or a milk or a milk concentrate within the starting milk composition to prepare the calcium-depleted milk composition.

18. A method as claimed in claim 17, wherein the calcium-depleted ingredient is selected from a non-fat milk powder, a fat standardised milk powder, and liquid concentrated non-fat milk or a liquid fat standardised concentrated milk.

19. A method as claimed in claim 18, wherein at least 15% of the exchangeable calcium in the ingredient is replaced by sodium or potassium or both.

20. A method as claimed in claim 19, wherein at least 50% of the exchangeable calcium in the ingredient is replaced by sodium or potassium.

21. A method as claimed in claim 17, wherein the calcium-depleted ingredient is selected from milk, fat standardised milk, skim milk and milk protein concentrate.

22. A method as claimed in claim 15, wherein the calcium-depleted milk composition to be acidified comprises 5-75% less calcium than the corresponding composition with corresponding ingredients without calcium depletion.

23. A method as claimed in claim 22, wherein the extent of calcium content is 10-60% less than in the corresponding composition.

24. A method as claimed in claim 22, wherein the extent of calcium content is 15-40% less than in the corresponding composition.

25. A method as claimed in claim 15, wherein the calcium to casein ratio of the composition to be acidified is in the range 0.017 to 0.05 w/w.

26. A method as claimed in claim 15, wherein the material to be fermented is heat-treated prior to acidification at 70-95° C.

27. A method as claimed in claim 15, wherein the casein to whey protein weight ratio is between 70:30 and 20:80.

28. A method as claimed in claim 15 wherein the casein to whey protein weight ratio is in the range 70:30 to 40:60.

29. A method as claimed in claim 15, wherein the yoghurt is a set or stirred yoghurt.

30. A method as claimed in claim 15, wherein the yoghurt is a drinking yoghurt or a Petit Suisse.
